(19) United States
(12) Patent Application Publication
(10) Pub. No.: US 2018/0355101 A1
(43) Pub. Date: Dec. 13, 2018

(54) THERMOPLASTIC COPOLYESTERS COMPRISING 1,4:3,6-DIANHYDROHEXITOL AND VARIOUS AROMATIC DIACIDS

(71) Applicant: ROQUETTE FRERES, LESTREM (FR)

(72) Inventors: Nicolas JACQUEL, LAMBERSART (FR); Gabriel DEGAND, LAMBRES (FR); René SAINT-LOUP, LOMME (FR)

(73) Assignee: ROQUETTE FRERES, LESTREM (FR)

(21) Appl. No.: 15/781,406

(22) PCT Filed: Dec. 2, 2016
(86) PCT No.: PCT/FR2016/053179

§ 371 Date: Jun. 4, 2018

(30) Foreign Application Priority Data
Dec. 2, 2015 (FR) 15 61757

(51) Int. Cl. C08G 63/189; C08G 63/672; C08G 63/80; C08L 67/02

(52) U.S. Cl. CPC C08G 63/189; C08G 63/672; C08L 2203/16; C08L 67/02; C08G 63/80

(57) ABSTRACT

A thermoplastic polyester having: at least one 1,4:3,6-dianhydrohexitol unit; at least one alicyclic diol unit other than 1,4:3,6-dianhydrohexitol units; at least one carboxylic diacid unit selected from among furan-2,5-dicarboxylic acid, 2,6-naphthalic acid and isophthalic acid units, said polyester including at least 10% 1,4:3,6-dianhydrohexitol units and being free from ethylene glycol and terephthalic acid units. The invention also relates to the production method and use of same.

### FIELD OF THE INVENTION

The present invention relates to a thermoplastic polyester free of ethylene glycol units and having a high degree of incorporation of 1,4:3,6-dianhydrohexitol units. Another subject of the invention is a process for producing said polyester and the use of this polyester for producing various articles.

### TECHNICAL BACKGROUND OF THE INVENTION

Because of their numerous advantages, plastics have become inescapable in the mass production of objects. Indeed, their thermoplastic character enables these materials to be transformed at a high rate into all kinds of objects.

Certain thermoplastic aromatic polyesters have thermal properties which allow them to be used directly for the manufacture of materials. They comprise aliphatic diol and aromatic diacid monomer units. Among these aromatic polyesters, mention may be made of polyethylene terephthalate (PET), which is a polyester comprising ethylene glycol and terephthalic acid units, used for example in the manufacture of containers, packaging, films or else fibers.

According to the invention, the term “monomer unit(s)” or “unit(s)” means units, included in the polyester, which may be obtained after polymerization of a monomer. With regard to the ethylene glycol and terephthalic acid units included in PET, they can be obtained either by esterification reaction of ethylene glycol and terephthalic acid, or by transesterification reaction of ethylene glycol and terephthalic acid ester.

However, for certain applications or under certain usage conditions, these polyesters do not have all the required properties, especially optical, impact strength or else heat resistance properties. This is why glycol-modified PETs (PETgs) have been developed. They are generally polyesters comprising, in addition to the ethylene glycol and terephthalic acid units, cyclohexanedimethanol (CHDM) units. The introduction of this diol into the PET enables it to adapt the properties to the intended application, for example to improve its impact strength or its optical properties, especially when the PETg is amorphous.

Other modified PETs have also been developed by introducing, into the polyester, 1,4:3,6-dianhydrohexitol units, especially isosorbide (PEIT). These modified polyesters have higher glass transition temperatures than the unmodified PETs or PETgs comprising CHDM. In addition, 1,4:3,6-dianhydrohexitols have the advantage of being able to be obtained from renewable resources such as starch. These modified polyesters are especially useful for manufacturing bottles, films, thick sheets, fibers or articles requiring high optical properties.

One problem with these PEITs is that they may have insufficient impact strength properties. In addition, the glass transition temperature may be insufficient for certain applications.

In order to improve the impact strength properties of the polyesters, it is known from the prior art to use polyesters in which the crystallinity has been reduced. With regard to isosorbide-based polyesters, mention may be made of application US 2012/0177854 which describes polyesters prepared from an acid component consisting of terephthalic acid and optionally of a minor amount of another aromatic diacid, such as phthalic acid, isophthalic acid or a naphthalene acid, and from a diol component consisting of from 1 to 60 mol % of isosorbide and from 5 to 99% of 1,4-cyclohexanedimethanol and optionally other diols, such as ethylene glycol. As indicated in the introductory section of this application, the aim is to obtain polymers in which the crystallinity is eliminated by the addition of comonomers, and hence in this case by the addition of 1,4-cyclohexanedimethanol. In the examples section, the manufacture of various poly(ethylene-co-1,4-cyclohexanedimethylene-co-isosorbide)terephthalates (PECITs), and also an example of poly(1,4-cyclohexanedimethylene-co-isosorbide)terephthalate (PCIT), are described. However, this application is totally silent with regard to the content of the various constituents in the final polyester.

Alternatives to PETs and modified PETs based on 2,5-furandicarboxylic acid have also been proposed. Patent application US 2013/0171397, for example, describes polyesters comprising ethylene glycol and 2,5-furandicarboxylic acid units (PEF) and also polyesters comprising ethylene glycol, isosorbide and 2,5-furandicarboxylic acid units (PEIF). The glass transition temperatures (T_{g} of the PEIFs remain relatively low with a maximum of 78° C., compared with 74° C. for a PEF, which indicates that the degree of isosorbide incorporation into the polyester is much lower than the amount of isosorbide used.

Patent application WO 2014/100257 gives a theoretical description of polyesters based on furandicarboxylic acid and on naphthalenedicarboxylic acid, comprising, in addition to these acid units, isosorbide units and optionally another polyol unit. However, this patent application discloses no actual example of implementation.

In general, one problem encountered in the production of polyesters comprising 1,4:3,6-dianhydrohexitol units, and in particular isosorbide units, is that the degree of incorporation of these units remains relatively low. A high degree of 1,4:3,6- dianhydrohexitol units is however desirable in order to achieve thermal performance levels, more particularly a glass transition temperature, that are sufficient for various applications, for instance in the packaging sector.

Thus, there is currently still a need to find new thermoplastic polyesters comprising 1,4:3,6-dianhydrohexitol units having a high thermal resistance which can be prepared efficiently and which advantageously at the same time have barrier properties with respect to gases, in particular to oxygen, to carbon dioxide and/or to water vapor.

It is to the applicant's credit to have found that this objective can be achieved with thermoplastic polyesters comprising 1,4:3,6-dianhydrohexitol units and which are free of ethylene glycol units and of terephthalic acid units.

### SUMMARY OF THE INVENTION

A subject of the invention is thus a thermoplastic polyester comprising:
at least one 1,4:3,6-dianhydrohexitol unit (A);
at least one alicyclic diol unit (B) other than the 1,4:3,6-dianhydrohexitol units (A);
at least one dicarboxylic acid unit (C) chosen from 2,5-furandicarboxylic acid, 2,6-naphthalene dicarboxylic acid and isophthalic acid units;
   said polyester containing at least 10% of 1,4:3,6-dianhydrohexitol units (A) relative to the total diol units present in the polyester and being free of ethylene glycol units and of terephthalic acid units.

Despite the large amounts of 1,4:3,6-dianhydrohexitol units known as agents which generate coloration in polyesters during polymerization, the applicant was able to observe that the polyesters according to the invention surprisingly exhibit low coloration.

This polymer may especially be obtained by a particular production process, especially comprising a step of introducing, into a reactor, monomers comprising at least one 1,4:3,6-dianhydrohexitol (A), at least one alicyclic diol (B) other than the 1,4:3,6-dianhydrohexitols (A) and at least one dicarboxylic acid (C) chosen from 2,5-furandicarboxylic acid, naphthalenedicarboxylic acid and isophthalic acid units, said monomers being free of ethylene glycol and of terephthalic acid.

This process comprises a step of polymerization, at a high temperature, of said monomers to form the polyester, said step consisting of:
a first stage of oligomerization, during which the reaction medium is firstly stirred under inert atmosphere at a temperature ranging from 120 to 250° C., advantageously from 125 to 210° C., more advantageously from 130 to 200° C., then brought to a temperature ranging from 210 to 300° C., advantageously ranging from 220 to 280° C., more advantageously from 225 to 265° C.;
a second stage of condensation of the oligomers, during which the oligomers formed are stirred under vacuum at a temperature ranging from 240 to 320° C. so as to form the polyester, advantageously from 255 to 310° C., more advantageously from 265 to 300° C.; and
   a step of recovering the polyester.

The applicant has observed, contrary to all expectations, that by not using ethylene glycol as diol monomer, it is possible to obtain novel thermoplastic polyesters having a high glass transition temperature. This would be explained by the fact that the reaction kinetics of ethylene glycol are much faster than those of 1,4:3,6-dianhydrohexitol, which greatly limits the integration of the latter into the polyester. The polyesters resulting therefrom thus have a low degree of integration of 1,4:3,6-dianhydrohexitol and consequently a relatively low glass transition temperature.

The polyester according to the invention has a high glass transition temperature and can be used in many tools for transforming plastics, and especially can be easily transformed by blow molding. It also has excellent impact strength properties.

### DETAILED DESCRIPTION OF THE INVENTION

The polymer which is a subject of the invention is a thermoplastic polyester comprising:
at least one 1,4:3,6-dianhydrohexitol unit (A);
at least one alicyclic diol unit (B) other than the 1,4:3,6-dianhydrohexitol units (A);
at least one dicarboxylic acid unit (C) chosen from 2,5-furandicarboxylic acid, 2,6-naphthalenedicarboxylic acid and isophthalic acid units;
   said polyester containing at least 10% of 1,4:3,6-dianhydrohexitol units (A) relative to the total diol units present in the polyester and being free of ethylene glycol units and of terephthalic acid units.

As explained above, the polyester according to the invention has a high glass transition temperature. Advantageously, it has a glass transition temperature of at least 95° C., preferably of at least 100° C., more preferentially of at least 110° C. and more preferentially still of at least 120° C. In a particular embodiment, the polyester according to the invention has a glass transition temperature ranging from 95° C. to 155° C., preferably from 100° C. to 150° C., more preferentially from 110° C. to 147° C., more preferentially still from 120° C. to 145° C.

The glass transition temperature is measured by conventional methods, especially using differential scanning calorimetry (DSC) using a heating rate of 10° C./min. The experimental protocol is described in detail in the examples section below.

The polyester according to the invention also has good barrier properties with respect to gases, in particular to oxygen, to carbon dioxide and/or to water vapor. Advantageously, it has a CO₂-permeability of less than 0.30 barrer, an oxygen-permeability of less than 0.11 barrer and a water vapour-permeability of less than 370 barrer. The barrier properties can be evaluated on films as a function of the gas respectively according to the standards ASTM D1434, ASTD3985 and ASTM F1249.

The unit (A) is a 1,4:3,6-dianhydrohexitol. As explained previously, 1,4:3,6-dianhydrohexitols have the drawback of being secondary diols which are not very reactive in the production of polyesters. The 1,4:3,6-dianhydrohexitol (A) may be isosorbide, isomannide, isoidide, or a mixture thereof. Preferably, the 1,4:3,6-dianhydrohexitol (A) is isosorbide.

Isosorbide, isomannide and isoidide may be obtained, respectively, by dehydration of sorbitol, of mannitol and of iditol or by isomerization of another of these dianhydrohexitols. As regards isosorbide, it is sold by the applicant under the brand name Polysorb® P.

The polyester according to the invention preferably has at least 12%, preferably at least 15%, more preferentially at least 20%, and more preferentially still at least 30% of 1,4:3,6-dianhydrohexitol units (A) relative to all the diol units present in the polyester.

The amount of 1,4:3,6-dianhydrohexitol units (A) in the polyester may be determined by ¹H NMR or by chromatographic analysis of the mixture of monomers resulting from complete hydrolysis or methanolysis of the polyester, preferably by ¹H NMR.

Those skilled in the art can easily find the analysis conditions for determining the amount of 1,4:3,6-dianhydrohexitol units (A) of the polyester. For example, from an NMR spectrum of a poly(1,4-cyclohexanedimethylene-co-isosorbide isophthalate), the chemical shifts relating to the 1,4-cyclohexanedimethanol are between 0.9 and 2.4 ppm and 4.0 and 4.5 ppm, and the chemical shifts relating to the isosorbide are between 4.1 and 5.8 ppm. The integration of each signal makes it possible to determine the relative amount of a unit relative to all of the two units.

The alicyclic diol (B) is also referred to as aliphatic and cyclic diol. It is a diol which may especially be chosen from 1,4-cyclohexanedimethanol, 1,2-cyclohexanedimethanol, 1,3-cyclohexanedimethanol or a mixture of these diols. The alicyclic diol (B) is very preferentially 1,4-cyclohexanedimethanol. The alicyclic diol (B) may be in the cis configuration, in the trans configuration, or may be a mixture of diols in the cis and trans configurations. In one particular embodiment, a cis/trans mixture of (1,4-cyclohexanedimethanol is used.

According to one embodiment, the polyester contains only one type of dicarboxylic acid unit (C) chosen from 2,5-furandicarboxylic acid, 2,6-naphthalenedicarboxylic acid and isophthalic acid units. In other words, according to this embodiment, the polyester of the invention contains at least one 2,5-furandicarboxylic acid unit or at least one 2,6-naphthalenedicarboxylic acid unit or at least one isophthalic acid unit.

Advantageously, the polyester according to the invention has a reduced viscosity in solution of greater than 40 ml/g, preferably greater than 45 ml/g, and more preferentially greater than 50 ml/g. The reduced viscosity in solution is evaluated using an Ubbelohde capillary viscometer at 35° C. The polymer is dissolved beforehand in ortho-chlorophenol at 130° C. with magnetic stirring. For these measurements, the polymer concentration introduced is 5 g/l.

The polyester of the invention may for example comprise:
a molar amount of 1,4:3,6-dianhydrohexitol units (A) ranging from 5 to 45%;
a molar amount of alicyclic diol units (B) other than the 1,4:3,6-dianhydrohexitol units (A) ranging from 3 to 47%;
a molar amount of dicarboxylic acid units (C) ranging from 48 to 52%.

The amounts of different units in the polyester may be determined by ¹H NMR or by chromatographic analysis of the mixture of monomers resulting from complete hydrolysis or methanolysis of the polyester, preferably by ¹H NMR.

Those skilled in the art can readily find the analysis conditions for determining the amounts of each of the units of the polyester. For example, from an NMR spectrum of a poly(1,4-cyclohexanedimethylene-co-isosorbide isophthalate), the chemical shifts relating to the 1,4-cyclohexanedimethanol are between 0.9 and 2.4 ppm and 4.0 and 4.5 ppm, the chemical shifts relating to the isophthalate ring are between 7.1 and 9.0 ppm and the chemical shifts relating to the isosorbide are between 4.1 and 5.8 ppm. The integration of each signal makes it possible to determine the amount of each unit of the polyester.

The polyester according to the invention may be semi-crystalline or amorphous.

When the polyester according to the invention is semi-crystalline, it advantageously has a crystallization temperature ranging from 150 to 250° C., preferably from 160 to 230° C. for example from 170 to 225° C.

Preferably, when the polyester according to the invention is semi-crystalline, it has a melting point ranging from 210 to 320° C., for example from 225 to 310° C.

The melting point is measured by conventional methods, especially using differential scanning calorimetry (DSC) using a heating rate of 10° C./min. The experimental protocol is described in detail in the examples section below.

Another subject of the invention is a process for producing the polyester according to the invention. This process comprises:
a step of introducing, into a reactor, monomers comprising at least one 1,4:3,6-dianhydrohexitol (A), at least one alicyclic diol (B) other than the 1,4:3,6-dianhydrohexitols (A) and at least one diacid (C) chosen from 2,5-furandicarboxylic acid, 2,6-naphthalenedicarboxylic acid and isophthalic acid, said monomers being free of ethylene glycol and of terephthalic acid;
a step of introducing, into the reactor, a catalytic system;
a step of polymerizing said monomers to form the polyester, said step consisting of:
   a first stage of oligomerization, during which the reaction medium is firstly stirred under inert atmosphere at a temperature ranging from 120 to 250° C., advantageously from 125 to 210° C., more advantageously from 130 to 200° C., then brought to a temperature ranging from 210 to 300° C., advantageously ranging from 220 to 280° C., more advantageously from 225 to 265° C.;
   a second stage of condensation of the oligomers, during which the oligomers formed are stirred under vacuum at a temperature ranging from 240 to 320° C. so as to form the polyester, advantageously from 255 to 310° C., more advantageously from 265 to 300° C.;
a step of recovering the polyester.

If the polyester according to the invention is semi-crystalline, this process may comprise a step of solid-state post-condensation under vacuum or while flushing with an inert gas, such as nitrogen (N₂) for example, and at a temperature lower by 5 to 30° C. than the melting point of the polyester.

Catalytic system is intended to mean a catalyst or a mixture of catalysts, optionally dispersed or fixed on an inert support.

The catalytic system is advantageously selected from the group consisting of tin derivatives, preferentially derivatives of tin, titanium, zirconium, germanium, antimony, bismuth, hafnium, magnesium, cerium, zinc, cobalt, iron, manganese, calcium, strontium, sodium, potassium, aluminum or lithium, or of a mixture of two or more of these catalysts. Examples of such compounds may for example be those given in patent EP 1 882 712 B1 in paragraphs [0090] to [0094].

The catalyst is preferably a derivative of tin, titanium, germanium, aluminum or antimony, more preferentially a derivative of tin or a derivative of germanium, for example dibutyltin dioxide or germanium oxide.

The catalytic system is used in catalytic amounts customarily used for the production of aromatic polyesters. By way of example of amounts by weight, use may be made of from 10 to 500 ppm of catalytic system during the stage of condensation of the oligomers, relative to the amount of monomers introduced.

According to the process of the invention, an antioxidant is advantageously used during the step of polymerization of the monomers. These antioxidants make it possible to reduce the coloration of the polyester obtained. The antioxidants may be primary and/or secondary antioxidants. The primary antioxidant may be a sterically hindered phenol, such as the compounds Hostanox® 0 3, Hostanox® 0 10, Hostanox® 0 16, Ultranox® 210, Ultranox® 276, Dovernox® 10, Dovernox® 76, Dovernox® 3114, Irganox® 1010 or Irganox® 1076 or a phosphonate such as Irgamod® 195. The secondary antioxidant may be trivalent phosphorus compounds such as Ultranox® 626, Doverphos® S-9228, Hostanox® P-EPQ or Irgafos 168.

It is also possible to introduce as polymerization additive into the reactor at least one compound that is capable of limiting unwanted etherification reactions, such as sodium acetate, tetramethylammonium hydroxide or tetraethylammonium hydroxide.

The process of the invention comprises a step of recovering the polyester resulting from the polymerization step. The polyester can be recovered by extracting it from the reactor in the form of a molten polymer rod. This rod can be transformed into granules using conventional granulation techniques.

Another subject of the invention is a polyester that can be obtained by the process of the invention.

The invention also relates to a composition comprising the polyester according to the invention, this composition possibly also comprising at least one additive or at least one additional polymer or at least one mixture thereof.

The polyester composition according to the invention may comprise the polymerization additives optionally used during the process. It may also comprise other additives and/or additional polymers that are generally added during a subsequent thermomechanical mixing step.

By way of examples of additives, mention may be made of fillers or fibers of organic or mineral, nanometric or non-nanometric, functionalized or non-functionalized nature. They may be silicas, zeolites, glass fibers or beads, clays, mica, titanates, silicates, graphite, calcium carbonate, carbon nanotubes, wood fibers, carbon fibers, polymer fibers, proteins, cellulose-based fibers, lignocellulosic fibers and non-destructured granular starch. These fillers or fibers can make it possible to improve the hardness, the rigidity or the water- or gas-permeability. The composition may comprise from 0.1% to 75% by weight of fillers and/or fibers relative to the total weight of the composition, for example from 0.5% to 50%. The additive that is of use in the composition according to the invention may also comprise opacifiers, dyes and pigments. They may be chosen from cobalt acetate and the following compounds: HS-325 Sandoplast® Red BB (which is a compound bearing an azo function, also known under the name Solvent Red 195), HS-510 Sandoplast® Blue 2B which is an anthraquinone, Polysynthren® Blue R, and Clariant® RSB Violet.

The composition may also comprise, as additive, a processing aid, for reducing the pressure in the processing tool. A demolding agent which makes it possible to reduce the adhesion to the materials for forming the polyester, such as the molds or the calendering rollers, may also be used. These aids may be selected from fatty acid esters and fatty acid amides, metal salts, soaps, paraffins and hydrocarbon-based waxes. Particular examples of these aids are zinc stearate, calcium stearate, aluminum stearate, stearamides, erucamides, behenamides, beeswaxes or candelilla wax.

The composition according to the invention may also comprise other additives, such as stabilizers, for example light stabilizers, UV stabilizers and heat stabilizers, fluidizers, flame retardants and antistatic agents.

The composition may also comprise an additional polymer other than the polyester according to the invention. This polymer may be chosen from polyamides, polyesters other than the polyester according to the invention, polystyrene, styrene copolymers, styrene-acrylonitrile copolymers, styrene-acrylonitrile-butadiene copolymers, poly(methyl methacrylate)s, acrylic copolymers, poly(ether-imide)s, poly(phenylene oxide)s, such as poly(2,6-dimethylphenylene oxide), poly(phenylene sulfate)s, poly(ester-carbonate)s, polycarbonates, polysulfones, polysulfone ethers, polyether ketones, and mixtures of these polymers.

The composition may also comprise, as additional polymer, a polymer for improving the impact properties of the polymer, in particular functional polyolefins such as functionalized ethylene or propylene polymers and copolymers, core-shell copolymers or block copolymers.

The composition according to the invention may also comprise polymers of natural origin, such as starch, cellulose, chitosans, alginates, proteins such as gluten, pea proteins, casein, collagen, gelatin or lignin, these polymers of natural origin possibly being physically or chemically modified. The starch may be used in destructured or plasticized form. In the latter case, the plasticizer may be water or a polyol, especially glycerol, polyglycerol, isosorbide, sorbitans, sorbitol, mannitol or else urea. The process described in document WO 2010/010 282 A1 may especially be used to prepare the composition.

The composition according to the invention may be produced by conventional thermoplastics mixing methods. These conventional methods comprise at least one step of mixing the polymers in the molten or softened state and a step of recovering the composition. This process may be performed in paddle or rotor internal mixers, external mixers, or single-screw or twin-screw co-rotating or counter-rotating extruders. However, it is preferred to produce this mixture by extrusion, especially using a co-rotating extruder.

The mixing of the constituents of the composition may take place under an inert atmosphere.

In the case of an extruder, the various constituents of the composition may be introduced by means of feed hoppers located along the extruder.

The invention also relates to the use of the polyester or of the composition in the packaging field, in particular for manufacturing fibers and yarns, films, sheets or hollow bodies, or in the optical article field, in particular for manufacturing optical films or lenses.

The invention also relates to a plastic, finished or semi-finished article comprising the polyester or the composition according to the invention.

This article may be of any type and may be obtained using conventional transformation techniques.

These techniques may for example, for fibers or yarns, be techniques that are well known to those skilled in the art, such as spinning-drawing, electrospinning for example.

Said article may for example be a film or a sheet, in particular for use in the packaging field. These films or sheets may be manufactured by the techniques of calendering, extrusion film cast, extrusion film blowing, followed or not by monoaxial or polyaxial stretching or orientation techniques.

The article according to the invention may also be a hollow article, in particular for use in the packaging field. The article may be bottles, for example sparkling or still water bottles, juice bottles, soda bottles, carboys, alcoholic drink bottles, small bottles, for example small medicine bottles, small bottles for cosmetic products, these small bottles possibly being aerosols, dishes, for example for ready meals, microwave dishes, pots, for example yogurt pots, stewed fruit pots or cosmetic product pots, or else lids. These containers may be of any size. They may be manufactured by extrusion blow molding, thermoforming or injection blow molding.

The article according to the invention may also be an optical article, i.e. an article requiring good optical properties, such as lenses, disks, transparent or translucent panels, light-emitting diode (LED) components, optical fibers, films for LCD screens or else windows. By virtue of the high glass transition temperature of the polyester according to the invention, the optical articles have the advantage of being able to be placed close to sources of light and therefore of heat, while retaining excellent dimensional stability and good resistance to light.

The articles may also be multilayer articles, at least one layer of which comprises the polymer or the composition according to the invention. These articles may be manufactured via a process comprising a coextrusion step in the case where the materials of the various layers are brought into contact in the molten state. By way of example, mention may be made of the techniques of tube coextrusion, profile coextrusion, coextrusion blow molding of a bottle, a small bottle or a tank, generally collated under the term “coextrusion blow molding of hollow bodies”, coextrusion blow molding, also known as film blowing, and cast coextrusion.

They may also be manufactured according to a process comprising a step of applying a layer of molten polyester onto a layer based on organic polymer, metal or adhesive composition in the solid state. This step may be performed by pressing, by overmolding, stratification or lamination, extrusion-lamination, coating, extrusion-coating or spreading.

The article according to the invention may also be a fiber, a thread or a filament. The filaments may be obtained by various processes such as wet spinning, dry spinning, melt spinning, gel spinning (or dry-wet spinning), or else electrospinning. The filaments obtained by spinning may also be stretched or oriented.

The filaments, if desired, may be cut into short fibers; this makes it possible to mix these fibers with other fibers to create mixtures and obtain a thread.

The threads or filaments may also be woven, for the manufacture of fabrics for the clothing industry, carpets, curtains, wall hangings, household linens, wall coverings, boat sails, furniture fabrics or else safety belts or straps.

The threads, fibers or filaments may also be used in technical applications as reinforcers, such as in pipes, power belts, tires, or as a reinforcer in any other polymer matrix.

The threads, fibers or filaments may also be assembled in the form of nonwovens (e.g. felts), in the form of ropes, or else knitted in the form of nets.

The invention will now be illustrated in the examples hereinafter. It is specified that these examples do not in any way limit the present invention.

### EXAMPLES

The properties of the polymers were studied via the following techniques:

The thermal properties of the polyesters were measured by differential scanning calorimetry (DSC): The sample is first heated under a nitrogen atmosphere in an open crucible from 10° C. to 320° C. (10° C. min⁻¹), cooled to 10° C. (10° C. min⁻¹), then heated again to 320° C. under the same conditions as the first step. The glass transition temperatures were taken at the mid-point of the second heating. Any crystallization temperatures are determined on the exothermic peak (onset) at cooling. Any melting points are determined on the endothermic peak (onset) at the second heating. Similarly, the enthalpy of fusion (area under the curve) is determined at the second heating.

The reduced viscosity in solution is evaluated using an Ubbelohde capillary viscometer at 35° C. The polymer is dissolved beforehand in ortho-chlorophenol at 130° C. with magnetic stirring. For these measurements, the polymer concentration introduced is 5 g/l.

The content of isosorbide of the final polyester was determined by ¹H NMR by integrating the signals relating to each unit of the polyester.

For the illustrative examples presented below, the following reagents were used:
Ethylene glycol (purity >99.8%) from Sigma-Aldrich
(1,4-Cyclohexanedimethanol (99% purity, mixture of cis and trans isomers)
Isosorbide (purity >99.5%) Polysorb® P from Roquette Frères
2,5-Furandicarboxylic acid (purity 99.7%) from Satachem
Isophthalic acid (purity 99%) from Aldrich . . .
2,6-Naphthalenedicarboxylic acid (purity 99.8%) from BASF
Germanium dioxide (>99.99%) from Sigma-Aldrich
Dibutyltin dioxide (purity 98%) from Sigma-Aldrich

Preparation of the polyesters:

### Example 1

50 g of 2,5-furandicarboxylic acid, 21.6 g of (1,4-cyclohexanedimethanol (ratio cis/trans: 70/30), 7.3 g of isosorbide and 15 mg of germanium oxide are introduced into a reactor. The mixture is stirred by mechanical stirring at 150 rpm and is heated to 130° C. over the course of 10 min under a nitrogen stream. Still under a nitrogen stream and mechanical stirring, the reaction medium is then maintained at 140° C. for 10 minutes, before being again heated to 200° C. over the course of 20 minutes. This temperature is maintained for 20 minutes. The temperature is then again increased up to 225° C. over the course of 20 minutes and is maintained for 2 h 30.

Following this, the temperature is increased to 265° C., the pressure is reduced over the course of 30 min to 0.7 mbar and the stirring speed is reduced to 50 rpm. These conditions will be maintained for 3 h.

The polymer obtained is a semi-crystalline material, the glass transition temperature of which is 111° C., the crystallization temperature of which is 175° C., the melting point of which is 229° C. and the viscosity index of which is 54.7 ml/g (concentration at 5g/l in 2-chlorophenol at 35° C.). The analysis of the final polyester by NMR shows that 23% of isosorbide (relative to diols) has been introduced into the polymer chains.

### Example 1a

The polyester of example 1 is used in a solid-state post-condensation step. First of all, the polymer is crystallized for 2 h in an oven under vacuum at 170° C. The crystallized polymer is then introduced into an oil bath rotavap fitted with a cannulated flask. The granules are then subjected to a temperature of 220° C. and a nitrogen flow of 3.3 1/min. After 31 h of post-condensation, the polymer will have a viscosity in solution of 71.2 ml/g.

### Example 2

50 g of 2,5-furandicarboxylic acid, 17.3 g of (1,4-cyclohexanedimethanol (ratio cis/trans: 70/30), 11.0 g of isosorbide and 20 mg of germanium oxide are introduced into a reactor. The mixture is stirred by mechanical stirring at 150 rpm and is heated to 130° C. over the course of 10 min under a nitrogen stream. Still under a nitrogen stream and mechanical stirring, the reaction medium is then maintained at 140° C. for 10 minutes, before being again heated to 200° C. over the course of 20 minutes. This temperature is maintained for 20 minutes. The temperature is then again increased up to 225° C. over the course of 20 minutes and is maintained for 3 h 30.

Following this, the temperature is increased to 265° C., the pressure is reduced over the course of 30 min to 0.7 mbar and the stirring speed is reduced to 50 rpm. These conditions will be maintained for 5 h.

The polymer obtained is an amorphous material, the glass transition temperature of which is 123° C. and the viscosity index of which is 47.5 ml/g (concentration at 5g/l in 2-chlorophenol at 35° C.). The analysis of the final polyester by NMR shows that 37% of isosorbide (relative to diols) has been introduced into the polymer chains.

### Example 3

25 g of isophthalic acid, 16.8 g of (1,4-cyclohexanedimethanol (ratio cis/trans: 70/30), 9.2 g of isosorbide and 17 mg of dibutyltin dioxide are introduced into a reactor. The mixture is stirred by mechanical stirring at 150 rpm and is heated to 190° C. over the course of 15 min under a nitrogen stream. Still under a nitrogen stream and mechanical stirring, the reaction medium is then maintained at 190° C. for 10 minutes, before being again heated to 250° C. over the course of 30 minutes. This temperature is maintained for 2 h 30. Following this, the temperature is increased to 280° C., the pressure is reduced over the course of 1 hour to 0.7 mbar and the stirring speed is reduced to 50 rpm. These conditions will be maintained for 3 h.

The polymer obtained is an amorphous material, the glass transition temperature of which is 97° C. and the viscosity index of which is 46.8 ml/g (concentration at 5g/l in 2-chlorophenol at 35° C.). The analysis of the final polyester by NMR shows that 29% of isosorbide (relative to diols) has been introduced into the polymer chains.

### Example 4

25 g of 2,6-naphthalenedicarboxylic acid, 12 g of (1,4-cyclohexanedimethanol (ratio cis/trans: 70/30), 8 g of isosorbide and 27 mg of dibutyltin dioxide are introduced into a reactor. The mixture is stirred by mechanical stirring at 150 rpm and is heated to 190° C. over the course of 15 min under a nitrogen stream. Still under a nitrogen stream and mechanical stirring, the reaction medium is then maintained at 190° C. for 10 minutes, before being again heated to 265° C. over the course of 30 minutes. This temperature is maintained for 3 h 30.

Following this, the temperature is increased to 300° C., the pressure is reduced over the course of 1 hour to 0.7 mbar and the stirring speed is reduced to 50 rpm. These conditions will be maintained for 5 h.

The polymer obtained is a semi-crystalline material, the glass transition temperature of which is 140° C., the crystallization temperature of which is 221° C., the melting point of which is 272° C. and the viscosity index of which is 43.5 ml/g. The analysis of the final polyester by NMR shows that 30% of isosorbide (relative to diols) has been introduced into the polymer chains.

### Example 4a

The polyester of example 4 is used in a solid-state post-condensation step. First of all, the polymer is crystallized for 2 h in an oven under vacuum at 190° C. The crystallized polymer is then introduced into an oil bath rotavap fitted with a cannulated flask. The granules are then subjected to a temperature of 260° C. and a nitrogen flow of 3.3 1/min. After 35 h of post-condensation, the polymer will have a viscosity in solution of 75.3 ml/g.

1. A thermoplastic polyester comprising:
at least one 1,4:3,6-dianhydrohexitol (A)unit;
at least one alicyclic diol unit other than the 1,4:3,6-dianhydrohexitol units;
at least one dicarboxylic acid unit chosen from 2,5-furandicarboxylic acid, 2,6-naphthalic acid and isophthalic acid units;
said polyester containing at least 10% of 1,4:3,6-dianhydrohexitol units (A)units and being free of ethylene glycol units and of terephthalic acid units.

2. The polyester as claimed in claim 1, having a glass transition temperature of at least 95° C.

3. The polyester as claimed in claim 1, wherein the 1,4:3,6-dianhydrohexitol is isosorbide.

4. The polyester as claimed in claim 1, wherein the alicyclic diol is a diol chosen from (1,4-cyclohexanedimethanol, 1,2-cyclohexanedimethanol, 1,3-cyclohexanedimethanol or a mixture of these diols.

5. The polyester as claimed in claim 1, wherein the polyester comprises:
a molar amount of 1,4:3,6-dianhydrohexitol units ranging from 5 to 45%;
a molar amount of alicyclic diol units other than the 1,4:3,6-dianhydrohexitol units ranging from 3 to 47%;
a molar amount of dicarboxylic acid units ranging from 48 to 52%.

6. The polyester as claimed in claim 1, wherein it is amorphous.

7. The polyester as claimed in claim 1, wherein it is semi-crystalline.

8. A process for producing the polyester as claimed in claim 1, said process comprising:
a step of introducing, into a reactor, monomers comprising at least one 1,4:3,6-dianhydrohexitol, at least one alicyclic diol other than the 1,4:3,6-dianhydrohexitols and at least one diacid chosen from 2,5-furandicarboxylic acid, 2,6-naphthalic acid and isophthalic acid, said monomers being free of ethylene glycol and of terephthalic acid;
a step of introducing, into the reactor, a catalytic system;
a step of polymerizing said monomers to form the polyester, said step consisting of:
a first stage of oligomerization, during which the reaction medium is firstly stirred under inert atmosphere at a temperature ranging from 120 to 250° C., then brought to a temperature ranging from 210 to 300° C.,
a second stage of condensation of the oligomers, during which the oligomers formed are stirred under vacuum at a temperature ranging from 240 to 320° C. so as to form the polyester, and
a step of recovering the polyester.

9. The process as claimed in claim 8, wherein the polyester is semi-crystalline and the process comprises a step of solid-state post-condensation under vacuum or while flushing with an inert gas and at a temperature lower by 5 to 30° C. than the melting point of the polyester.

10. A polyester able to be obtained by the process as claimed in claim 8.

11. A polyester composition comprising a polyester as claimed in claim 1.

12. A method comprising applying the polyester as claimed in claim 1, in the packaging field or in the optical article field.

13. A plastic article comprising a polyester as claimed in claim 1.
